(19) United States
(12) Patent Application Publication
(10) Pub. No.: US 2019/0220875 A1
(43) Pub. Date: Jul. 18, 2019

(54) SYSTEMS AND METHODS FOR PERSONALIZED DISCOVERY ENGINES

(71) Applicant: Node Inc., San Francisco, CA (US)

(72) Inventor: Falon Fatemi, San Francisco, CA (US)

(21) Appl. No.: 16/337,027

(22) PCT Filed: Oct. 2, 2017
(86) PCT No.: PCT/US2017/054741

§ 371 Date: Mar. 27, 2019

Related U.S. Application Data
(60) Provisional application No. 62/402,705, filed on Sep. 30, 2016.

(51) Int. Cl. G06Q 30/02; G06Q 30/06; G06Q 50/00

(52) U.S. Cl. CPC G06Q 30/0201; G06Q 50/01; G06Q 30/0609

(57) ABSTRACT

Methods and systems for providing recommendations to identify and/or engage potential customers are provided. A plurality of characteristics of a node profile associated with a set of potential customers are determined. Additionally, a computer processor that is programmed to identify characteristics of potential customers is used to analyze an entity-based data intelligence layer to identify node profiles that match at least a threshold number of the plurality of characteristics associated with the set of potential customers. One or more recommendations are associated with the identified node profiles of potential customers. Further, said one or more recommendations of potential customers are presented to the user.

### CROSS-REFERENCE TO RELATED APPLICATIONS

This application claims priority to U.S. Provisional Patent Application No. 62/402,705 (Attorney Docket No. 45796-702.101) filed on Sep. 30, 2016, which is entirely incorporated by reference.

### BACKGROUND

In the sales industry, it is difficult to identify potential customers that may be receptive to a particular selling opportunity. Information about potential customers may be difficult to search using only keywords, and returned information that is associated with potential customers may be difficult to analyze without additional context.

### SUMMARY

There is more information created in a single day than an individual can absorb in a lifetime. In particular, there is so much relevant information being created every day that a user is not able to determine what they should be searching for. Because of this, machines are used to understand what users care for and proactively identify what is relevant to a user. In some cases, machines are used to make sense of people, companies, products, and places on the web, then understand what you care about, and facilitate recommendations of the right people and companies at the right time, personalized to a user. Using systems and methods provided herein, intelligent personalized recommendations may be provided. Additionally, explanations of the reasons behind recommendations may be provided as well as relevancy of recommendations to a user. As such, systems and method as provided herein may be used as personalized discovery engines.

In some examples, systems and methods described herein may utilize connections between a user and other entities in determining recommendations for the user. In particular, some embodiments of discovery engines may emphasize connections a user has with other entities above the content within an entity. Further, the context of a user may influence or govern the recommendations that are presented to a user. In this way, context may be used to drive the recommendations that are provided to the user. In particular, information that is stored about a person may be organized based on that person's particular connections and/or context.

Data related to a user may be associated with particular nodes, such as relationships; people; companies; technologies; and services. Additionally, these nodes may be enriched with data, entities, and/or signals. Further, different entities may collect and generate distinct webs of data associated with different categories. For example, clouds having webs of data may be categorized based on sales; marketing; business development; customer relationship management (CRM); commerce; or recruiting, among others.

Methods and systems as provided herein may analyze and process collected data so as to provide personalized recommendations for users. In some examples, a web page that is identified may be analyzed to determine content that is relevant to a user. In particular, the web page may be assessed based on an identification of people, companies, products, and/or unique keyphrases. This information may then be used in generating connections associated with a user. As discussed herein, methods and systems may be directed to generating a personal CRM. The personal CRM may provide personal recommendations to users. These recommendations can be used to power personalized discovery in applications, systems of record, and action systems that the Node system integrates with. An example of such an integration could be an integration with a CRM like Salesforce.

In some examples, users may include companies that are interested in finding potential customers. In some examples, users may include individuals that are interested in having an application that provides powered personalized intelligence. Personal, or people-based, intelligence may connect relationships between different entities while understanding a person at the center, which allows companies to provide desired opportunities at the right time, in whatever application the person at the center is using. The personal intelligence may provide recommendations to users based on social connections, companies of interest, job opportunities, articles, etc. Personal CRM is an example of a Node application that may be powered by the Node discovery engine. Personal CRMs may be applied to sales and marketing, as well as recruiting, business development, and powering personalized intelligence, among other applications.

When these systems and methods are applied to a sales industry, companies that are looking to identify contacts within potential customers may benefit from improved web intelligence that organizes collected information based on entities rather than keywords. When these systems and methods are applied to the sales and marketing industry, for example, Node can help businesses understand their total addressable market of potential customers and benefit from Node's ability to dynamically track the changes within their addressable market, and make recommendations for which markets and prospects to focus on first at both the people and company level.

In particular, collected data may be analyzed to determine actionable insights for finding and/or engaging potential customers. For example, Node has an understanding of said business in its data layer. In some cases it understands the customers publicly inferenced that a business has. In some cases it understands the industry a business may be in based on keyphrases Node has ranked associated with the company and mapped to Node's proprietary industry ontology. Node understands the competitors, customers of competitors, and attributes about them. Node is able make recommendations to that business without marrying this graph information with their CRM data, however when doing that it can make more targeted recommendations for potential customers that will drive more revenue per unit of time. Node is able to do this because it is also able to analyze people and companies the customer has been successful at selling to and not been successful at selling to using Node's understanding of attributes about those people and companies to generate the query, called the ideal customer profile which then Node is able to explain the reasons behind these recommendations in human readable language.

In recruiting and other context, this ideal customer profile may become the ideal candidate profile, or ideal job profile and returns a ranked list of people and company recommendations and insights from the Node data layer, specific to the company and the user. In some cases, collected data may include recommended times for engaging potential customers. In some cases, collected data may include a range of times when a potential customer may be more likely to act on a product offering. Ranges of time may include a particular one or more hours of day for engaging the customer; a particular one or more days of week for engaging the customer; a particular month or moths of year for engaging the customer, etc. In some cases, collected data may include recommended media for engaging potential customers. In some cases collected data may include recommendations for engaging potential customers via social media, text, e-mail, phone, in-person, or a combination. By providing a data structure that utilizes information that is found in connecting entities, such as people and businesses, the additional information that is gained by generating relationship data based on the collected data may be used to provide recommendations to customers that would not readily be determined based on the assessment of the collected data outside of a relationship-based context. For each entity that is recommended, systems and methods as provided herein may ensure the recommendations are actionable. In particular, systems and methods may provide an email address, phone number, and/or other contact information when presenting a recommendation. In some cases, systems and methods described herein may use machine learning to recognize common email patterns across companies and people, and may understand based on existing profiles what domains are being used for corporate emails.

Using systems and methods provided herein, companies may determine a total addressable market of potential customers for a company's product. Additionally, a company may develop one or more ideal customer profiles of potential customers for the company's profile. An ideal customer profile may be a set of attributes/characteristics that the system has identified as representing an optimal set of people and companies the organization should sell to that will accelerate their revenue (i.e. bring them more revenue faster that is higher win rate, deal size, shorter sales cycle). A Diagnostic may generate attributes for the ICP, and this may be used to query the data layer and recommend people and companies as prospects. Once these two aspects have been established, information that is within an entity-based data intelligence layer may be used to generate insights into how to engage potential customers. In this way, the entity-based data intelligence layer may aid a company in determining which potential customers to engage and/or provide suggestions on how to engage potential customers.

Examples of beneficial aspects of systems and methods described herein include richness of data; recency of data; relationships of data; breadth of data; data network effects; scalability of data; and architecture. Each of these aspects is discussed more herein.

Regarding richness of data, systems and methods described herein provide for building out a data intelligence layer that may be used to capture and/or store many different aspects about people, companies, and other entities of interest. Our data layer is not limited to just the information needed for use cases today. Rather, the data layer may be built to model for planned and speculative features many product iterations out. When new information/recommendations are identified, those new recommendations may be integrated to the data layer, which as a flexible and holistic approach to entity modeling. In some examples, a data layer may comprise information related to people, companies, products, places, and keywords. The data layer may include over half a billion profiles or more. In some cases, the data layer that is constructed in this way may have around 80% accuracy. In some cases, the data layer may have over 60% accuracy. In some cases, the data layer may have 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or over 99% accuracy.

Regarding recency of data, systems and methods of constructing a data intelligence layer recognize that information is constantly being updated. The business world is in constant flux, and we've built our data layer to embrace this by both recording corporate and professional histories and constantly seeking to update and validate our data. We've developed and refined techniques that have brought us up to 90% precision on current company employment checks, while incumbent vendors struggle to validate whether their contacts are even real people.

Regarding relationships of data, systems and methods of building a data intelligence layer recognize that events in business do not happen in a vacuum. Funding, employment, partnerships, personal relationships, and other such relationships among people and companies are the connections that our customers rely on to navigate to their business goals. Extracting these relationships and storing them in an accessible way allows this information to be utilized by companies when identifying and engaging potential customers.

Regarding breadth of data, the flexibility of a data intelligence layer as discussed herein allows for modelling of many different aspects, such as people, companies, products, and/or intangibles. A data intelligence layer as provided herein may be indiscriminate with respect to particular models that are being built. At the same time, as a data intelligence layer adds more sources of information, and adds new entities, new relationships may be built with previously existing entities thereby improving the overall utility of data within the data intelligence layer.

Regarding data network effects, data collection methodology and integration with other online platforms, such as Salesforce, may be used to give systems as described herein access to living, ever-growing training and validation sets. Accordingly, systems as described herein may be placed in a competitive position to refine its recommendations over time. When systems as provided herein are used in a sales industry context, every day in which a sales or marketing professional does his or her job, systems grow more intelligent with every new customer and every time data is refreshed to include new information.

Regarding scalability, a data intelligence layer may be built on top of extremely scalable data stores. This architecture may allow a system to not only collect extremely large amounts of information, but also to process and extract information and insights. Systems constructed in this way may have the ability to process structured and unstructured data, and merge, enrich and cross referencing information rapidly. Additionally, using commodity hardware may also provide a technological advantage of systems described herein.

Regarding data architecture, a strong separation of concern may be maintained within various systems. In particular, certain critical infrastructure can be shared between current and future product offerings. Entities created and enriched as a by-product of utilization by one product may become available to other products. In some examples, the use of one product may enhance other corresponding products. In some examples, logical separation may be created between data assets of systems provided herein and sensitive customer information. In this way, risk profile of systems may be minimized while maximizing the value of shared data assets.

In one aspect of the invention, a method for providing recommendations to identify and/or engage potential customers is provided. The method comprises determining a plurality of characteristics of a node profile associated with a set of potential customers. The method also comprises using a computer processor that is programmed to identify characteristics of potential customers, analyzing an entity-based data intelligence layer to identify node profiles that match at least a threshold number of the plurality of characteristics associated with the set of potential customers. The method also comprises associating one or more recommendations with the identified node profiles of potential customers. Additionally, the method comprises presenting said one or more recommendations of potential customers to the user.

In another aspect of the invention, a computer system for providing recommendations to identify and/or engage potential customers is provided. The computer system comprises an electronic display comprising a user interface that is configured to present recommendations to a user. The computer system also comprises a computer processor coupled to said electronic display, wherein said computer processor is programmed to (i) determine a plurality of characteristics of a node profile associated with a set of potential customers; (ii) analyze an entity-based data intelligence layer to identify node profiles that match at least a threshold number of the plurality of characteristics associated with the set of potential customers; (iii) associate one or more recommendations with the identified node profiles of potential customers; and (iv) present said one or more recommendations of potential customers to the user.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 illustrates an example of determining and compiling data for a node profile of a person, in accordance with some embodiments.

FIG. 2 illustrates additional information related to the node person represented in the node person profile, in accordance with some embodiments.

FIG. 3 illustrates probabilistic entity keyword association, in accordance with some embodiments.

FIG. 4 provides an illustration of composite profile deduplication, in accordance with embodiments.

FIG. 5 illustrates data points connected within a node graph, in accordance with some embodiments.

FIG. 6 illustrates two identified individuals having similar interests, in accordance with some embodiments.

FIG. 7 provides a schematic of a data layer in accordance with some embodiments.

FIG. 8 provides a schematic of data layer analysis, in accordance with some embodiments.

FIG. 9 provides a schematic of data layer access, in accordance with some embodiments.

FIG. 10 provides an example of Sales Velocity, in accordance with some embodiments.

FIG. 11 provides a BrandCo revenue summary, in accordance with some embodiments.

FIG. 12 provides examples of strategic recommendations for a new business, in accordance with some embodiments.

FIG. 13 provides a measure of usage for a BrandCo company, in accordance with some embodiments.

FIG. 14 provides measures of revenue, in accordance with some embodiments.

FIG. 15 provides other measures of revenue, in accordance with some embodiments.

FIG. 16 provides examples of customers, in accordance with some embodiments.

FIG. 17 provides examples of a total addressable market, in accordance with some embodiments.

FIG. 18 illustrates a computer control system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

In the sales, marketing, recruiting world it is difficult to proactively identify the world of potential customers, hires, and job opportunities as well a prioritize your execution of the market of possible hires and job opportunities in an efficient and relevant manner. Today search helps us find what we're looking for when we know a specific customer or hire we are researching, but for the people and companies you don't know you should be searching for a discovery engine is required to facilitate proactive and relevant recommendations, at the right time in whatever application you're in. This includes recommendations for example of the people you should know and why, the companies you should research and why, the right time to reach out, and even personalized recommendations for what you should say.

Systems and methods provided herein may be used to identify and provide recommendations for users. When identifying a person or entity for making a recommendation, systems and methods may conduct an analysis, such as on a public webpage, to extract information that may be useful. In a case of a person that is described on a public webpage, systems and methods described herein may analyze the webpage to determine what type of content is associated with the webpage. In particular, the systems and methods may determine if content of the webpage is associated with an article, a product page, a blog post, an event page, a press release, or another type of content. This analysis may be made more efficient by stripping out advertisements and/or other aspects of the webpage that may not be relevant to the primary content of the webpage itself. Additionally, different areas and different aspects of the webpage may also be identified and analyzed. In some cases, such as a webpage containing and article, systems and methods provided herein may discern between a headline, body, and/or other portions of the webpage. Based on these different categories of information, processes such as natural language processing and/or machine learning may be used to determine the main topic of the article. Similarly, when a webpage include event information, systems and methods may be used to correlate an event page back to a company it's associated with by domain and content on the event page. This may be used to associate that company and event and keyphrases that are extracted from the webpage with that company and/or with the people that are associated with the event. In some cases, open source tools like readability or alphabet soup or diffbot may be used to perform identification of page types and/or stripping of pages. Additionally, processes discussed herein may be use to discern the difference in unstructured text between different entities, such as a person, company, and/or keyword.

The present disclosure provides systems and methods for improving web intelligence. In particular, the present disclosure provides systems and methods of analyzing structured and/or unstructured data to generate a data intelligence layer structured around individuals and/or businesses. In examples, the data intelligence layer may be built as a graph of relationships between entities. Once the data intelligence layer architecture has been established, content may be fed into the data intelligence layer to establish and augment relationships between individuals and/or businesses.

Based on these relationships, suggestions may be generated for a user, such as an individual and/or business. Examples of suggestions may include product suggestions, event suggestions, and suggestions of individuals. In some cases, these suggestions are provided to the user without the use of a search box. Additionally, the data intelligence layer may be updated dynamically. Further, given that the data intelligence layer is structured around individuals and/or businesses, suggestions for an individual and/or business may be dynamically updated in response to a dynamic update to the data intelligence layer itself. This can advantageously enable individuals to receive suggestions that are most relevant to the individual. Additionally, this can advantageously enable businesses to provide suggestions to individuals who are targeted based on their likelihood of positively responding to suggestions.

As data is crawled, it may be examined using natural language processing models to extract entity information. This, in turn, may be used to feed a connection model, deduplication protocol, and/or disambiguation protocol within a data intelligence layer architecture. In additional cases, the difference between unstructured text between a person, company, and/or keyword may be discerned using natural language processing (NLP) and/or machine learning (ML) techniques. Examples of these tools include python nitk or Stanford open NER. Additionally, when utilizing crawled data in the data intelligence layer architecture, the system may make use of map reduce capabilities for ETL, backfill, integration of certain static data providers, search index generation, certain feature engineering for machine learning/statistical purposes, and data model alterations. Additional explanation of the data intelligence layer architecture, and methods for using the data intelligence architecture in providing benefits to customers, are discussed below.

### Data Intelligence Layer Architecture

In examples, a data intelligence layer architecture may comprise a plurality of data stores, two major data processing pipelines, and an API. An example of a data intelligence layer architecture includes web data and data from 3^{rd} party data providers. This web data and/or 3^{rd} party data providers may be processed using components such as an asynchronous engine, map reduction engine, custom data loaders, and/or a callback service. An asynchronous engine may include a relationship detector component. Additionally or alternatively, an asynchronous engine may include a named entity recognition/disambiguation component. Further, a map reduction engine may include a crawler component, a classifier component, a cross-referencing engine component, and/or a data backfill and ETL (Extract, Transform, Load) component.

Additionally, a data intelligence structure may include content storage components, such as an unstructured data store, a structured data cache, a news cache, a search index, and a profile storage component. A system may also include an API. Further, content that is retrieved from data storage may be provided to a customer data build pipeline. A customer data build pipeline may include a grader, ETL processes, a similarity detector, a trend detector, a relevance model, and/or a cross referencing agent. Additionally, customer data models as well as a presentation layer may be provided. In examples, the presentation layer may be in a customer CRM. Another example of a data intelligence layer architecture may comprise a map reduction engine having an improved deduplication module.

There are at least five classes of domain objects which may contribute to the functioning of the system. In examples, almost all functionality of the system is related to one or more of these objects: node profiles, authentications, application integrated options, strategy definition objects, and trend detectors.

Node profiles are domain objects that may be used to describe a particular entity. A node profile may typically be a named entity. In some examples, a node profile may be an individual. In some examples, a node profile may be a business. A node profile may be modeled using a variety of data sources. Further, a node profile may contain relationship information. In some examples, information in a node profile, such as a relationship, may be materialized for performance reasons.

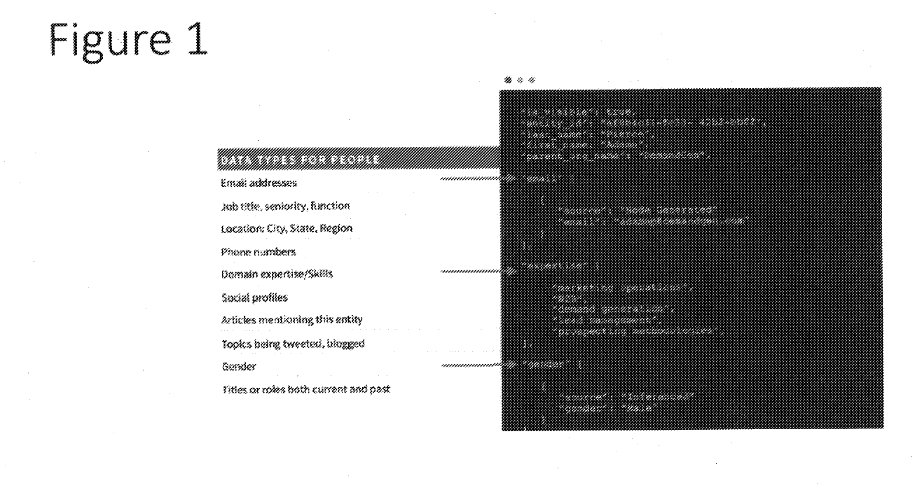

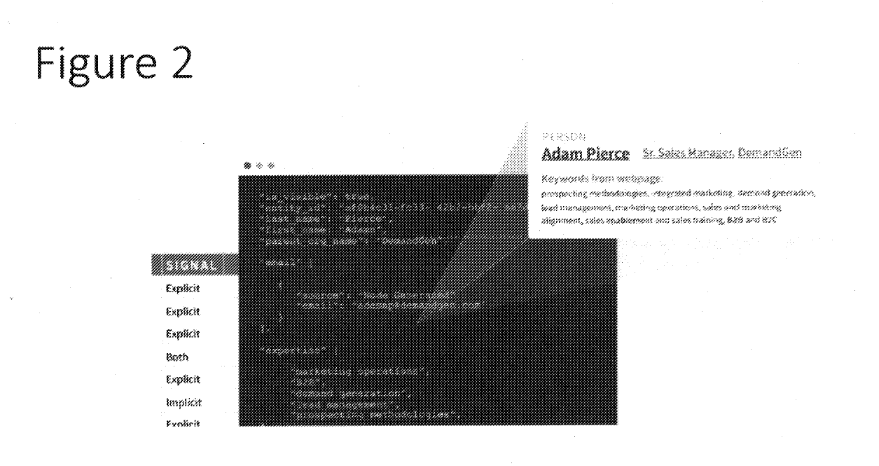

Node profiles may be generated when information related to a person who does not currently have a node profile is added to the data layer. In this case, a node associated with the person is generated and the information related to the person is linked to the node of the new person. The node of the new person may be generated by linked tracked attributes that are associated with the person to the node of the person. FIG. 1 illustrates an example of determining and compiling data for a node profile of a person, in accordance with some embodiments. Further, FIG. 2 illustrates additional information related to the node person represented in the node person profile, in accordance with some embodiments.

Information that is extracted so as to generated the node profiles may be extracted in such a way as to not violate terms of service associated with the person and/or sources of this information. In some cases, a node profile may be modified when a node related to a particular person is associated with supplemental information. During, before, or after this update, other information associated with the person's node profile may be checked to ensure the information is up to date. For example, if a company has successfully closed an investment round, the company's node profile may be augmented to add new connections to investors who have invested in the company. These investors may have their own node profile, which may be linked to the company in the context of “provided funding” to the company. If the investors do not already have a node profile, a node profile may be generated for the investors. In some cases, an updated node profile may be re-inserted into the node graph. In some cases, a node profile may be updated to increase connections and/or add new connections to new entities within the node graph.

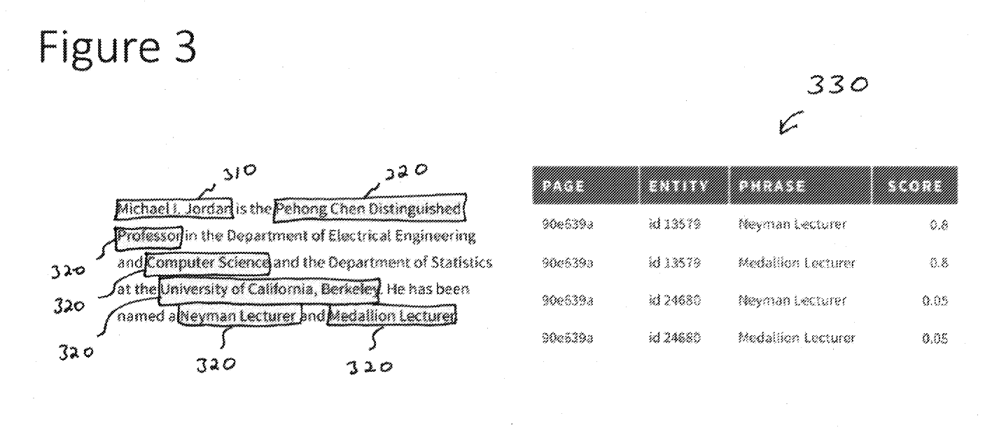

Additionally, when supplemental information is received that may be ambiguous between more than one node profile, disambiguation processes may be used to determine a most likely node profile associated with the supplemental information. In particular, FIG. 3 illustrates probabilistic entity keyword association, in accordance with some embodiments. As seen in FIG. 3, a passage includes text 310 that matches one or more existing named entities in the corpus of the data layer. Additionally, text 320 are phrases that have a high confidence as being associated with one of the named entities. As seen in the accompanying table 330 of FIG. 3, a cross-product of named entity phrase pairs for the page may be added to a large table of associations. In this example, “1357” refers to Michael Jordan, the professors, and “24680” refers to Michael Jordan the fitness trainer. As illustrated in FIG. 3, there is a strong association of “Neyman Lecturer” and “Medallion Lecturer” with the machine learning professor and a weak association with the fitness trainer.

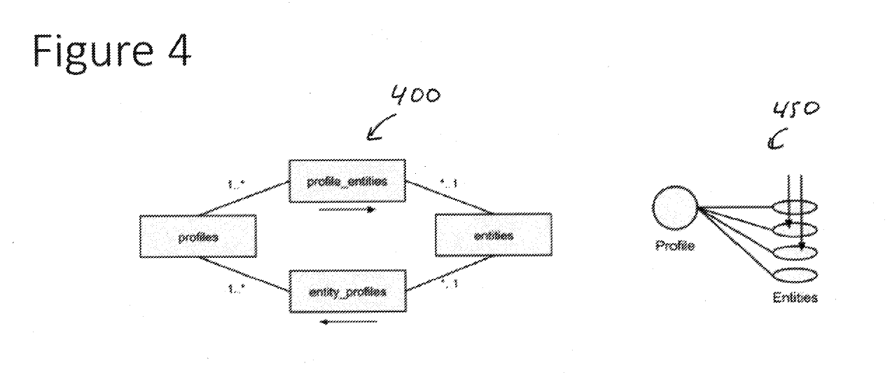

Another aspect of the data layer includes processes for eliminating duplicated profiles. In particular, the data layer provides composite profiles. One aspect of composite profiles includes entity completeness, which includes having a percentage of fields that are populated, giving additional weight to fields which help with disambiguation. Examples of fields that are beneficial in disambiguation include, but are not limited to: name, e-mail, phone number, job title, and employer. Another aspect of composite profiles includes entity recency. When applicable, more recent data may overwrite old data in composite profiles. A further aspect of composite profiles includes authoritativeness. In particular, a trust scoring system may be based on data resources that are more authoritative to resolve conflicts with data. Another aspect of composite profiles includes voting strategy. In particular, a most popular piece of data may be given preference over other data. In some cases, data that appears the most in a particular context may be given a preference over other data. FIG. 4 provides an illustration of composite profile deduplication, in accordance with embodiments. In particular, FIG. 4 provides schematic 400 to illustrate joint tables between profiles and entities. In some cases, data can be retrieved by using HBase prefix scans by profile ID (e.g., in the case of profile entities) or by entity ID (e.g., in the case of entity_profiles). Further, FIG. 4 also provides an illustration 450 of layering entities of a profile. In particular, when a profile consists of multiple duplicate entities, the data may be layered from each entity to provide a window into the data.

In some cases, a node profile associated with a company may be generated by analyzing firm and/or technological sources associated with the company. In some cases, systems and methods provided herein may crawl public filings formation information, financials, and/or websites associated with the company. Additionally, inferences about the industry may be based on keyphrases. Inferences may also be made based on ontology of the data layer as described herein. Additionally, inferences may be made based on North American Industry Classification System (NAICS) codes. Further, employee size can be obtained from public filings for taxes; parent/subsidiary information may be found from filings and financials so as to indicate percentage ownership; location of the company may be determined from primary domain and formation information (based on legal entities). Further, additionally information such as partnerships, board members, customers, blog posts, press releases, as well as job postings may be retrieved from public information sources.

In some cases, a node profile associated with a person may be generated by reviewing public information about a person, such as through public records and publicly available resumes. Further, a targeted crawl may also be used to gather additional information about a person. In particular, methods and systems provided may data extraction methods as mentions of people are found during crawling. Additionally, a targeted crawl may be aided by using search engine results as well as informed targeted crawling based on associations with other keyphrases, companies, and people to build profiles on people.

Information that is gathered may be processed so as to verify data quality and/or refresh information. In particular, systems and methods as provided herein may include an additional layer of verification on data points that are acquired. In some cases, assessed data points may have 80% average accuracy. In additional cases, a human enrichment team may provide feedback for machine learning processes and/or cleaning techniques during ETL. Additionally, logic may be applied to querying and/or surfacing to assess data integrity. For example, if an e-mail goes invalid, this may be assessed and determined using methods discussed herein. In some cases, information relating to a person's employment status may be updated when an e-mail verification determines that the e-mail associated with the person's last-known company is returned as invalid. In some cases, a person's updated employment may be determined by analyzing mentions of the person in news, in public social posts, in an updated resume, or in additional sources of information related to the person that may be crawled using systems and methods described herein.

Another type of domain objects are authentication objects. Authentication objects may be used to reflect the scope of permissions and logical separation of domain objects. In some examples, authentication objects may represent the permission given by a user to a system to access data for processing and cross referencing operations using customer data sets.

An additional type of domain object may include application integration objects. In examples, application integration objects may include a class of domain objects which model CRM objects associated with entities and data types in a system of record, such as a Salesforce integration.

An additional type of domain objects are strategy definition objects. In particular, strategy definition objects may be programmable domain objects, algorithms, and filters which relate to strategy characteristics.

A further type of domain objects may be trend detectors. Trend detectors are a class of objects which seek trends within specified time frames. In some examples, trend detectors may be augmented or replaced with more nuanced and defensible statistical methods as techniques and algorithms improve. In some examples, trend detectors may be supervised by one or more human operators. In some examples, trend detectors may be supplicated by one or more human operators.

In examples, the data intelligence layer architecture may have three layers: a data layer, a broker layer, and a presentation layer. Each layer is discussed further herein.

### Data Layer

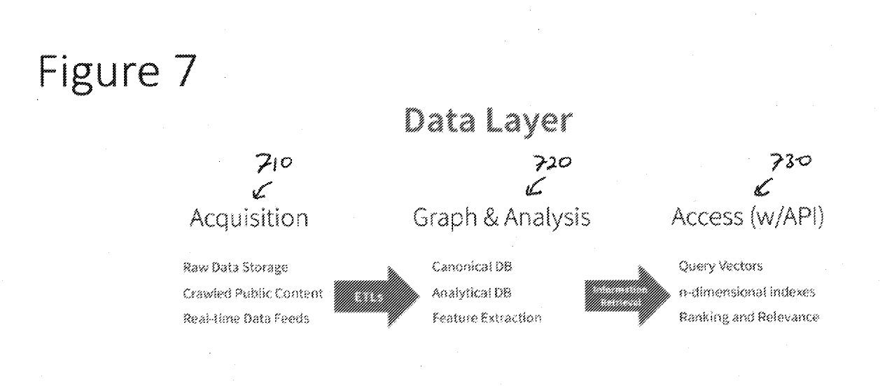

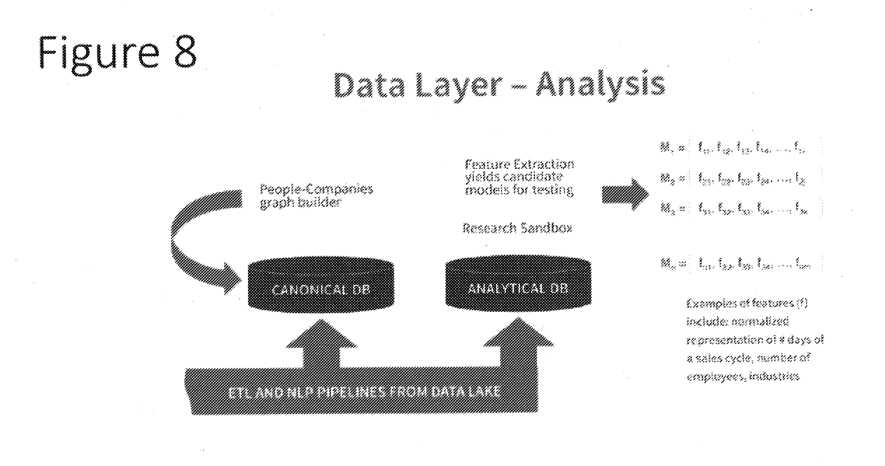

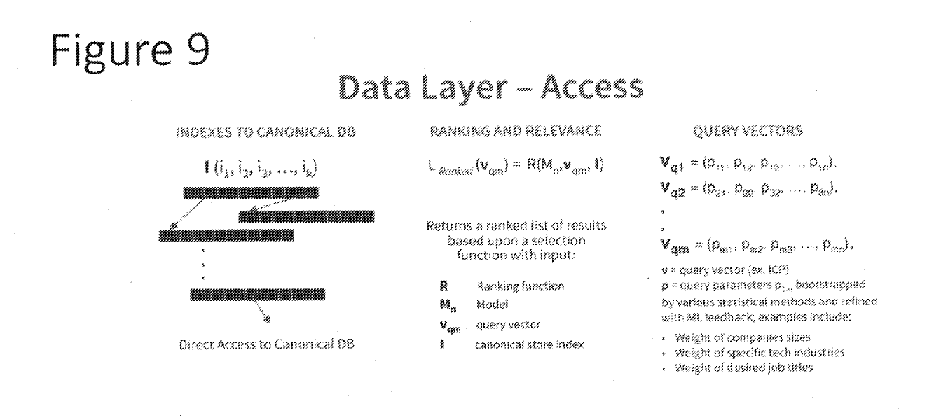

FIG. 7 provides a schematic of a data layer in accordance with some embodiments. As seen in FIG. 7, a data layer process may move from Acquisition 710 to Graph & Analysis 720 to Access 730. As seen in FIG. 7, and in some cases, Acquisition 710 may include raw data storage, crawled public content, and/or real-time data feeds. In some cases, Acquisition 710 may include real-time news feeds, structured third-party databases, crawled content, feedback events, and/or social media feeds. Acquisition 710 may include the collection of structured, semi-structured, unstructured, and/or raw data. From Acquisition 710, data may be process using extract, transform, load (ETL). The acquired data may then be processed into Graph & Analysis 720. In examples, Graph & Analysis 720 may include Canonical DB, Analytical DB, and/or Feature extraction. From Graph & Analysis 720, data may be retrieved using information retrieval processes so as to lead to Access 730. Further, Access 730 may include Query Vectors, n-dimensional indexes, and Ranking and Relevance. Additionally, FIG. 8 provides a schematic of data layer analysis, in accordance with some embodiments. Further, FIG. 9 provides a schematic of data layer access, in accordance with some embodiments.

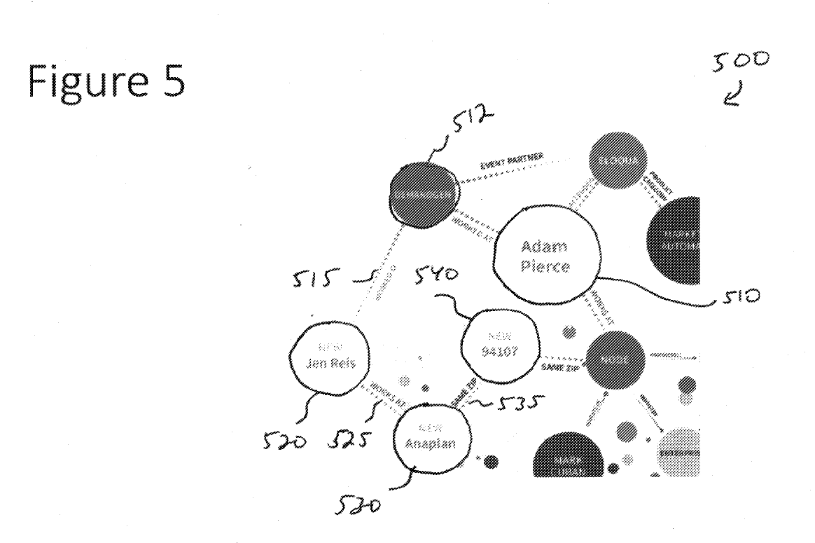

An example of a graph connecting data points is provided in FIG. 5. In particular, FIG. 5 illustrates data points connected within a node graph 500, in accordance with some embodiments. As seen in FIG. 5, entities 510, 512, 520, 530, and 540 are linked using connections such as 515, 525, and 535. In particular, a person 510, “Adam Pierce,” is linked to a company 512, “DEMANDGEN,” which is then further linked to a person 520, “Jen Reis.” Further the connection that links Adam Pierce to DEMANDGEN (not shown) and Jen Reis to DEMANDGEN (connection 515) is given the context “worked at.” Additional connections illustrated in FIG. 5 include connection 525 having the context “works at” and connection 535 having the context “same zip.” When connecting a node profile into the graph, the node profile may be linked to additional entities such as people, companies, products, places, expertise, keywords, industries, technologies, and/or other firmographics. In one case, if we know a person has been associated with a particular company in the past and if that company is associated with technographic information, an assumption may be made that the person is also associated with that technographic information. This assumption may then be reviewed and verified. As an example, if the person is in marketing then the person may be associated more heavily with marketing technology. In another example, if a person is attending a computing marketing event, then that person may be likely to have familiarity with computing technology. Additionally, the person may be determined to have a closer social proximity and strength of connection to the other industries that may attend a computer marketing event, as well as the people and companies in similar industries and technology categories, as well as the occupations of sales and marketing, as well as other attendees of the event.

In some cases, during the creation or refresh of a node profile associate with a person or entity, data points in the node profile may be connected with additional portions of an overall graph. When this is done, the process may recalculate the edges, strength of connection, social proximity to other people companies, products, places expertise, keywords, industries, and other firmographics, technographics, and demographics.

The data layer may be used to house significant quantities of data that may be accessible via an API. In some examples, the data layer of systems provided herein may relate to almost all parts of the non-customer data acquisition and management tooling.

As such, the data layer may contain raw data, and may also contain a series of acquiry, caching, data processing, information extraction, cross referencing, and/or API tooling to facilitate an entire lifecycle of both structured and unstructured data associated with entities.

In examples, a data layer may be used to harvest and process public and private, walled garden data from a variety of sources. The data layer may also contain a reasonably high performance asynchronous processing system, a map-reduce processing system, and/or a horizontally scalable search index with advanced text processing facilities.

### Broker Layer

The broker layer may have overarching responsibility to utilize functions associated with node profiles. Functions that are associated with node profiles may include looking up, searching, creating a model of customer data, and fusing the profiles available in the graph to customer data. Moreover, when the system is directed towards the sales industry, the broker layer may contain logic specific to the sales domain, such as sales techniques, various sales planning domain objects, and additional industry-specific modules.

The broker layer may have dedicated machine resources and data storage infrastructure. In examples, the broker layer may be logically separate from both customer systems (e.g., to protect node-assets and IP) and/or the data layer (e.g., to protect the customers from unwanted information sharing) via a strict separation of concern.

In some examples, the broker layer may also mediate requests for trigger events. A trigger event may occur when information is updated within a node profile of a particular entity. In an example, a trigger event may occur when an individual associated with a potential client may move from one company to another company. In this example, the broker system may assess whether the new company is in line with a profile of a potential customer. If the new company fits the profile of potential customer, information for the new company may be added and/or augmented to include information associated with the individual who has moved to the new company.

Additionally, the broker layer may mediate requests for domain-related search activities, such as net-new requests. In examples, these requests may be in the form of contact generation, account generation, other prospecting activities, or key contact generation. In some examples, significant portions of certain trend-detection logic may be based in the broker layer. Additionally, small amounts of bespoke code may be housed in the broker layer to support third party data deals.

In response to requests received, the broker layer may generate insights that are associated with a particular entity. In particular, the broker layer may analyze relationships of a particular entity with other information and/or domain objects associated with the entity and may provide insights accordingly. In some examples, insights may provide information that may be of interest to an individual. In some examples, insight may include recommendations of an individual to purchase a particular item or attend a particular event.

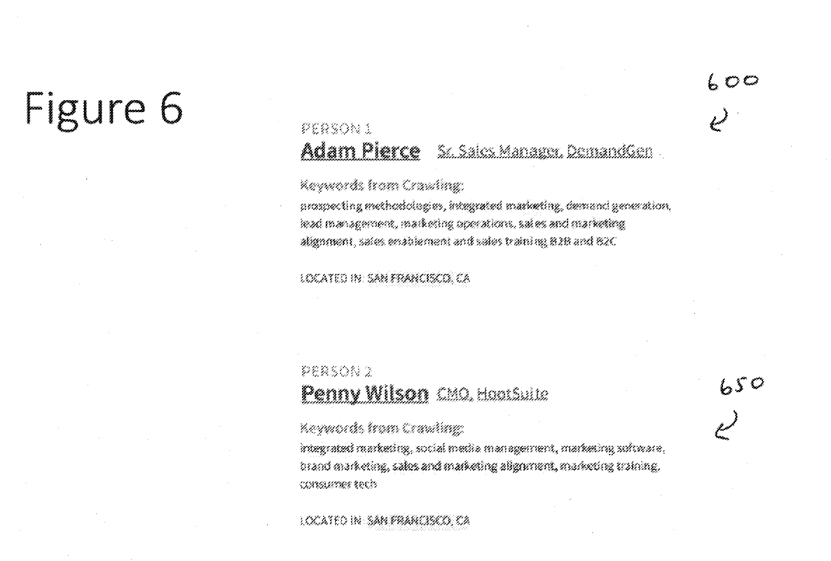

In some cases, recommendations may be made of individuals who may have similar interests. An example of two individuals identified as having similar interests is provided in FIG. 6. FIG. 6 illustrates two identified individuals having similar interests, in accordance with some embodiments. As seen in FIG. 6, Person 1 (“Adam Pierce”) 600 and Person 2 (“Penny Wilson”) 650 share similarity of location (“San Francisco”) as well as similarities of “integrated marketing” and “sales and marketing alignment.” These interests are extracted from data crawling in accordance with systems and methods provided herein. Based on these similarities, Person 1 and Person 2 may have interests in talking with one another, which may serve as a basis for recommendations that these two people connect with one another.

### Presentation Layer

Once insights have been generated at a broker layer, the insights may be presented to a company for identifying and/or engaging potential customers. The insights may be presented to a company, or other entity, in a report. The report may be presented on a user interface of an electronic device associated with the company. For example, the report may be provided to a sales associate of a company. The user interface may be a graphical user interface (GUI) or a web-based user interface. The electronic device may be a portable (or mobile) electronic device.

In some examples, a company may be presented with a one or more insights about potential customers that are object-specific. For example, a company may be provided with insights that are associated with a particular individual that has decision-making authority within a company that is a potential customer. In some examples, insights may include recommendations and research. In systems that are associated with the sales industry, insights may be recalculated on a regular basis to support sales activities.

Data enrichment activities may be performed offline and regularly loaded into customer CRM, such as via a local cache. In this way, a customer CRM may be turned into a content distribution system for systems as provided herein. Additionally, a small software component in a system of record, such as Salesforce, may undertake rendering activities and/or types of just-in-time operations, such as contact surfacing and trigger event loads.

### Methods for Providing Insights

In some aspects, the present disclosure provides methods for providing insights to companies regarding potential customers. Such methods can significantly improve the recommendations and/or research that are provided to a company in response to a requesting event. When these methods are utilized in the sales industry, this can help consumers to receive sales recommendations that are of greatest interest to them. Additionally, these methods may also be used to direct businesses to potential consumers that are most likely to be receptive to a sales pitch. When evaluating whether potential consumers would be receptive to a particular sales pitch, the potential consumers may be analyzed based on their past actions as well as analyzed based on current conditions. In particular, the potential consumers may be assessed based on whether a triggering event has occurred that may make the potential consumer more receptive to a particular sales pitch.

There are a number of factors that may be considered when providing insights to a company. A number of factors that may contribute to generating insights are described herein. Using the data intelligence layer, recommendations and insights that are made may not just be focused on past history, but may also include recommendations that are directed towards areas that have zero revenue or customers in a location, industry, or utilizing a technology etc. In particular, the system may provide recommendations based on next areas of opportunity because the system's data intelligence layer is massive and can identify that there are strong attributes/characteristics of potential customers that may not only drive more revenue, faster, but better revenue, higher deal sizes, win rates and shorter sales cycle time. An example of a formula that drives these recommendations for a system for Sales and Marketing may be the sales velocity formula referenced in the Diagnostic described further below. In particular, an example of a sales velocity formula relates a number of opportunities created multiplied by an average deal size (acv) multiplied by win rate %, the cumulative product then divided by sales cycle time. Accordingly, while recommendations may also be made based on past successes, as discussed below, these recommendations may also be made based on new opportunities and areas that do not yet currently have revenue or customers.

Analyzing Historical Data.

In some examples, the data intelligence layer may be used to collect and analyze historical data associated with a particular business. When systems and methods as provided herein are applied to the sales industry, companies that utilize the data intelligence layer may be analyzed to determine where the companies have been making the most money and what business has the company been doing. In this way, a company that is using systems and methods for finding potential customers may have a sales ecosystem constructed of potential customers using information that is provided in the data intelligence layer. This sales ecosystem may then be used to help a company identify and/or engage potential customers.

Cross-Referencing Information with Current Data.

In some examples, customer CRM's may be ineffective at housing much more than sales staff activity tracking, minor financial reporting for attribution and remuneration purposes, and customer identity cues (e.g., websites). In systems and methods provided herein, these categories of information may be augmented their data that is generated from the entity-based data intelligence layer architecture own data. In this way, information that is already known within a customer CRM may be given additional value as part of producing contextually relevant data.

Detecting Trends.

Once customer CRM data has been enriched with information from the entity-based data intelligence layer, the now-enriched data can provide previously unavailable insights into characteristics of potential customers. In particular, the now-enriched data may include information relating to a potential customer's location, industry, third tier technology usage, job titles, and/or trigger events.

Identifying Opportunities.

Using information that is generated using an entity-based data intelligence layer, companies may use an account-based strategy to identify parties that are able to make decisions regarding sales opportunities.

Model Third Tier Similarities.

Using systems described herein, companies may be able to detect similarities between current customers by modelling customer traits. Methods of detecting such similarities may provide a significant advantage to companies, as sales staff may able to better reference information associated with relationships of entities associated with a potential customer.

Cross-Referencing with Trigger Events.

The entity-based data intelligence layer may be used to detect recent corporate and/or personnel activities that may be relevant to the selling organization. In particular, the data intelligence layer may identify shifts in occupation among individuals that are associated with a company. Based on this information, companies may receive information that an individual who was previously a contact for approving a purchase is no longer associated with that position, or that an individual that was previously not a contact for approving a purchase has become a contact associated with the potential customer for approving a purchase. In this way, contextual data associated with potential customers may significantly help with timing and urgency related research into a given prospective client.

Grade.

Certain organizations may treat sales activities as a volume game. In this case, we have developed algorithms which individually measure a potential customer against past successes. Additionally, based on an assessment of the potential customer against past successes, a set of appropriate behaviors may be prescribed. For example, a high score may indicate that a customer is not only similar to other current customers, but may also be in a favorable time period. In examples, a favorable time period may be identified using a trigger events. Additionally, a high score may also indicate that a potential customer has traits seen in other emergent trends that indicate that a deal is more likely to close. Conversely, a low score may intimate that a deal is less likely with a particular potential customer. In cases where a particular potential customer is associated with a low score, a set of avoidance may be prescribed.

In some examples, a priority score may be provided. In particular, a priority score may provide a search score and/or relevancy ranking. A priority score may incorporate not only attributes of a user's next best customer, but may also factor in social proximity, strength of connection, and/or other attributes to make a personalized recommendation. A priority score may factor in both company level attributes as well as people level attributes. Additionally, a priority score may be personalized to particular users.

Social proximity algorithms and recommendations may include strengths of connection calculations between companies and between people. Examples may include an algorithm that looks at the social proximity of a particular company to an existing customer based on industry category, industry sub category, top key phrases, location, revenue, employee size, and whether they are competitors or not. Another example may include a closest connection feature which looks at the social proximity of the user/sales rep to the contact recommended by the system that can include commonalities such as strength and number of mutual connections, if they went to same school, worked at same company, have similar domain expertise and/or interests.

Collate Recommendations into Plans.

Once one or more prescribed actions are determined, the one or more prescribed actions may be packaged into a set of data structures which can be efficiently pushed into a customer-held cache for easy presentation. Additionally, packaging one or more prescribed actions in a packaged set of data structures, or a “plan,” may provide an additional benefit of efficient network and system of record resource utilization. In some examples, these plans may not only be personalized to a prospect or to an organization, but may also be personalized to the individual user (sales rep). In examples, a plan may show commonalities between a prospect (contact/person) and sales rep (e.g., that the prospect and sales rep went to the same university).

Surface Plans.

Data which has been built and cached in customer CRM's may require a presentation layer to maximise the utility of new data sources available to a customer. Certain fields may be materialized at a column level. Fields that are materialized at a column level may be used in email-campaigns, for example. Additionally, systems as provided herein may have a wealth of address information which can be used in a conventional, albeit targeted, mail campaign. Systems may also provide interfaces for the loading of just-in-time queries such as related trigger events and people searches.

Updating Information Based on Changing Events.

Once a data intelligence layer architecture is constructed, the data intelligence layer may be updated based on new information that is received. Data that is used to reflect the real world may change as the real world changes. Additionally, this data may be recorded in order for systems that utilize the data intelligence layer to improve. In some examples, no change in customer behavior may be required in such updates.

Collect Feedback.

Feedback collection can be as simple as collecting the most recent data and appending that data to a model prior to doing builds. Feedback collection may be complex and/or more qualitative, such as user-interviews or feature requests. Additionally, feedback collection may be used to create crowd-labelled data sets which may qualify problems with data to produce realistically labelled data sets. In additional examples, feedback may be collected based on successes, user behavior, activities, and macro trends. In some examples, the system may learn as it makes recommendations and gets smarter over time in making personalized recommendations to the organization and to the user.

Dynamic Recommendations from System.

In examples, the system may automatically adjust total addressable market opportunity as an organization's customer change over time. The total addressable market may also be changed based on successes and failures from customers based on deals closed as well as relationships that may change in a data intelligence layer as reflected on the web.

Additionally, strategies determined by the system to be most effective may be vetted with a customer by to ensure that maximum customer value is attained. This step may be beneficial in ensuring that the strategy is an agreed-upon item. If a strategy is executed that is not agreed-upon, performance may be impeded both at a data level and an organizational level, which may hinder adoption. Additionally, adjusting strategy may also address problems inherent with historical data set analysis, such as pivots, general strategy changes, and other non-historical factors which may be chosen by a customer.

Repeating Processes Based on New Information.

As new business opportunities emerge, new trends may emerge. The processes described above may be repeated and applied to new opportunities. Additionally, application of processes described above may be used to identify positive and/or negative emerging trends.

Recommendations to Person in Profile Independent of Other Data.

In some cases, recommendations may be made to a person that is not a user within systems and methods provided herein. For example, if a person has a node within the data intelligence layer but is not a user of the system, other users who want to make recommendations to the person can do so based on the information that is collected about the person and connecting that information into the node graph of the data intelligence layer. In particular, systems and methods provided herein may be used to provide recommendations to the person independent of other data. For example, if a person that is known to work at a computer search engine company is plugged into the node graph, information that indicates the person may have domain expertise in search advertising may be associated with the person. Additionally, if many other employees at the computer company have highly regarded university degrees, additional information that indicates the person is intelligent may be determined. Based on this analysis, job recommendations, articles, companies, and other recommendations of interest may be provided to the person even when the person is not a user of systems and methods described herein.

### Node Diagnostic

In examples, a diagnostic product may be provided on top of a data intelligence layer that generates recommendations for ideal customer profiles and a total addressable market for a customer. A data intelligence layer may comprise a graph of relationships between entities. The diagnostic may outline revenue concentration to date and may identify patterns and characteristics of current customers as well as the next set of customers for the organization so as to accelerate sales velocity.

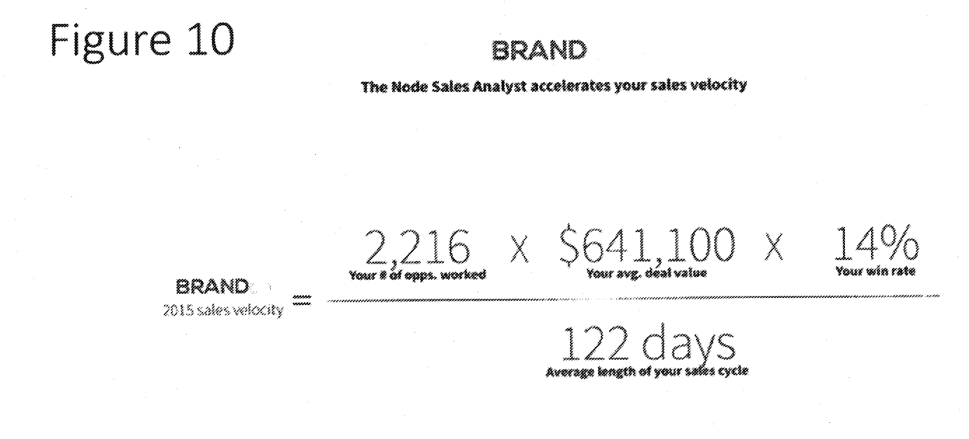

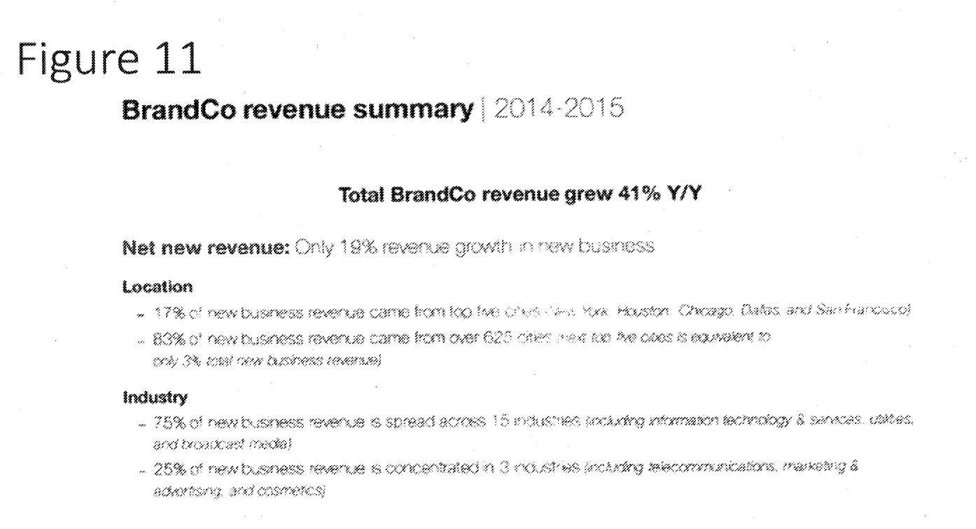

FIG. 10 provides an example of Sales Velocity, in accordance with embodiments. In particular, an example of Sales Velocity for an example company BrandCo may define a measure of sales velocity based on a comparison of number of opportunities worked, average deal value, and percentage win rate when viewed relative to an average length of a sales cycle. Additionally, FIG. 11 provides a BrandCo revenue summary, in accordance with embodiments.

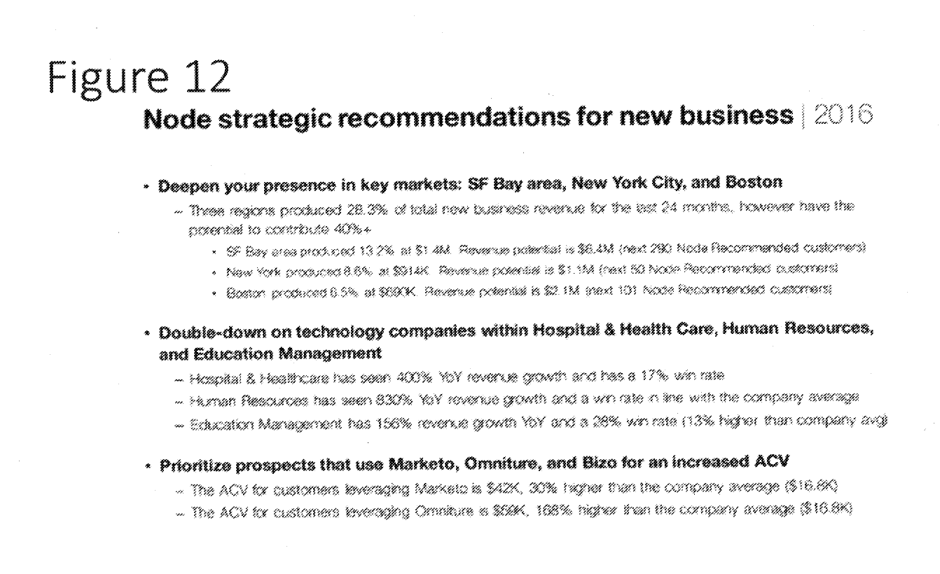

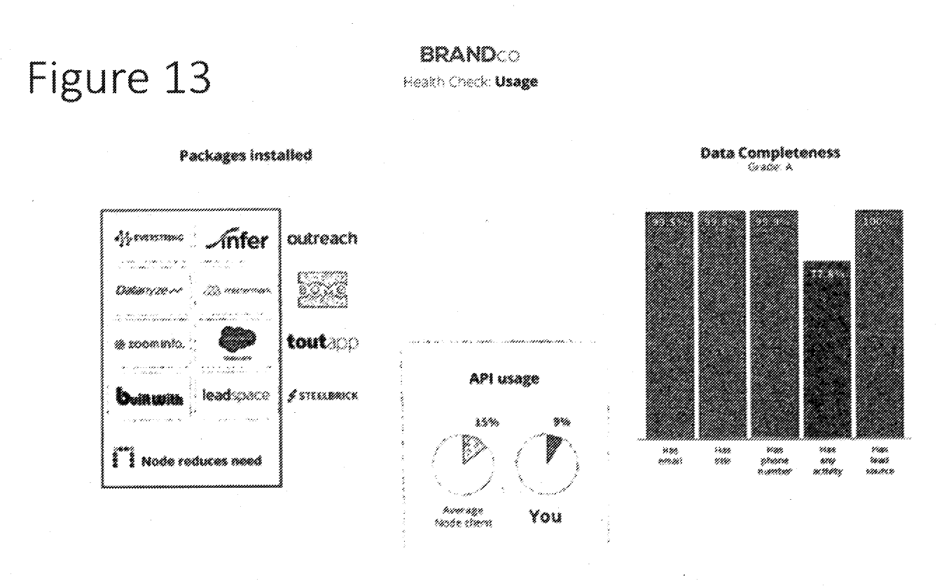

FIG. 12 provides examples of strategic recommendations for a new business, in accordance with embodiments. Additionally, FIG. 13 provides a measure of usage for a BrandCo company, in accordance with embodiments.

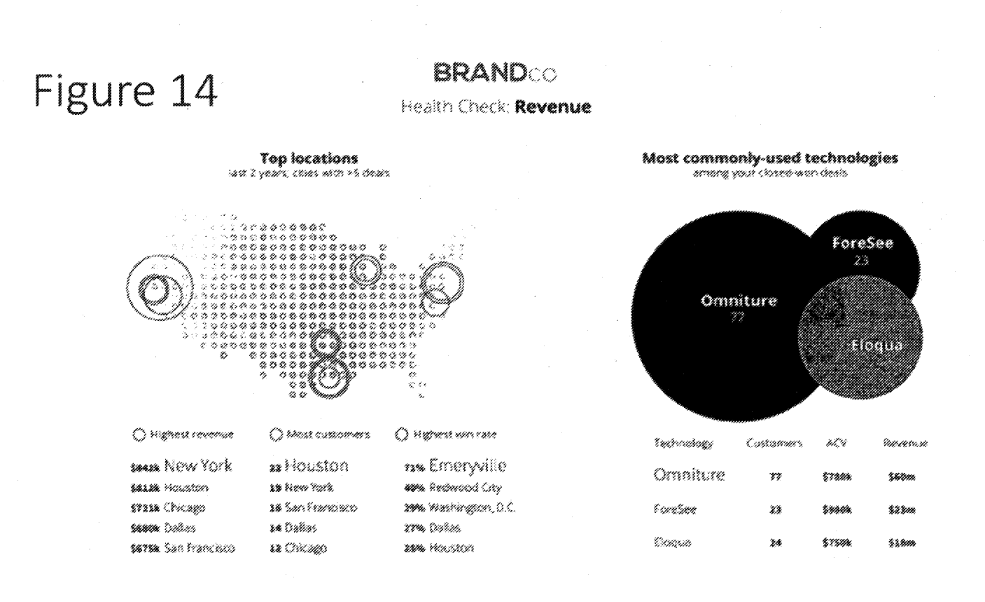

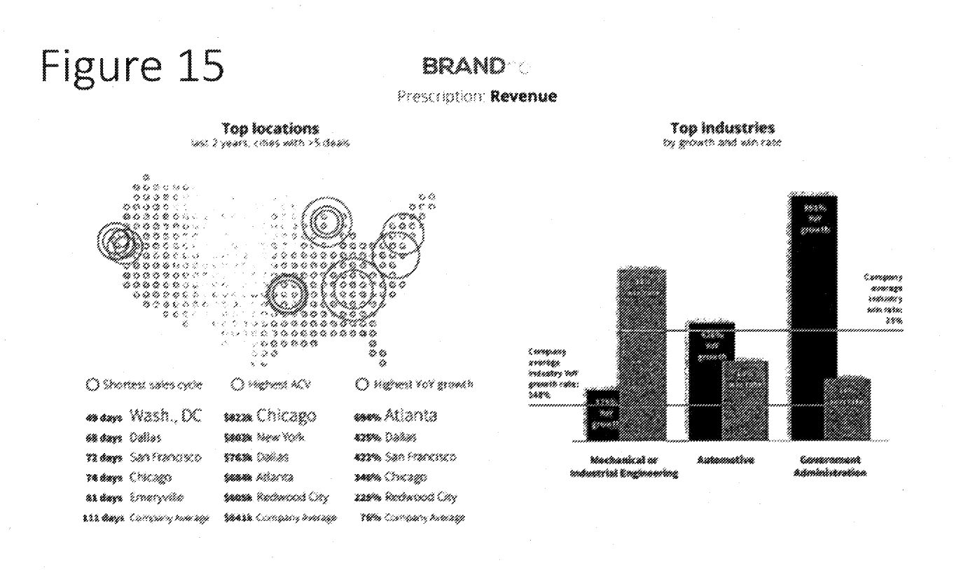

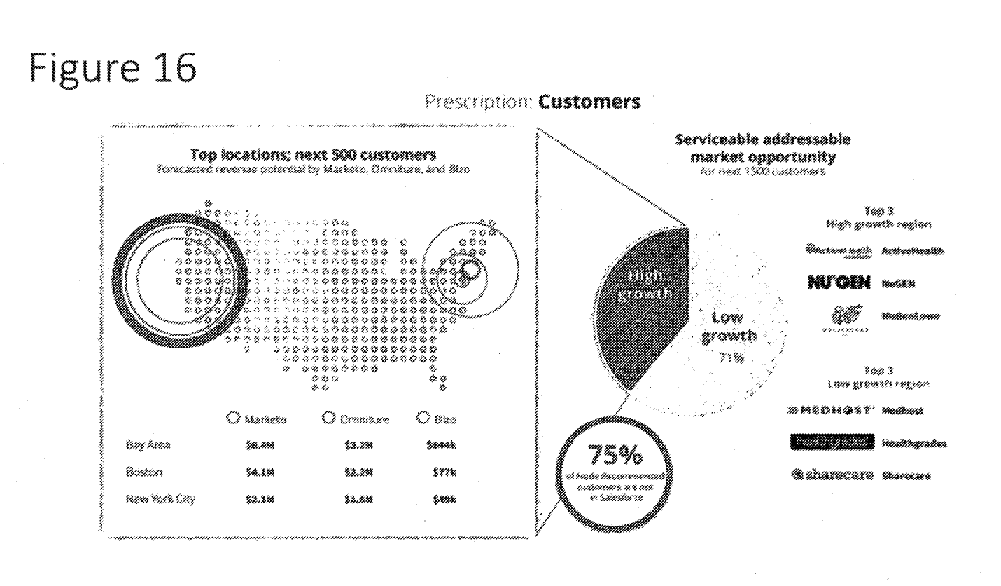

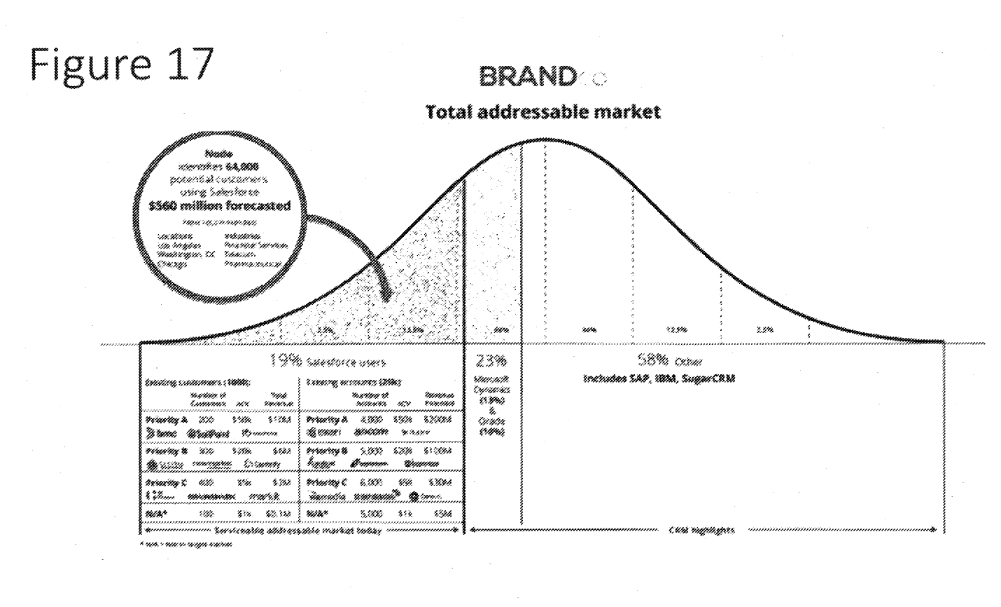

FIG. 14 provides measures of revenue, in accordance with embodiments. FIG. 15 provides other measures of revenue, in accordance with embodiments. FIG. 16 provides examples of customers, in accordance with embodiments. FIG. 17 provides examples of a total addressable market, in accordance with embodiments.

### EXAMPLES

In examples where systems and methods discussed herein are applied to the sales industry, the data intelligence layer may be used to generate recommendations for a sales representative to engage a potential customer. In particular, systems and methods may be used to provide sale representatives with recommendations of which potential customer the sales representative should engage; particular individuals at the potential customer that the sales representative should engage; when the sales representative should engage with the individual and/or potential customer; and what items the sales representative should mention when engaging with the individual and/or potential customer.

In some examples, sales representatives may be provided key attributes of a potential customer, such as technologies, firmographics, and other information that may be incorporated into a targeting strategy. The sales representative may also be provided with recommendations of locations having high concentrations of revenue, as well as locations that may be emerging as further areas of opportunity. In particular, systems and methods described herein may be used to identify next industry sectors that are exhibiting high growth and a higher than company average win rate. Further, systems, may analyze other signals across a company's set of existing customers such as commonly used technologies that correlate to a higher than company average deal size.

Data providers may include the system's data layer and/or web crawling. In some examples, systems as provided herein may use the web as a database. In particular, Sources of data may include web data, 3^{rd} party data providers, and/or new data, in addition to other examples. Additionally, an asynchronous engine and a map reduce engine may be used to process the data. In particular, the asynchronous engine may comprise a relationship detector component. The asynchronous engine may also comprise a named entity recognition/disambiguation component. Additionally, the map reduce engine may comprise a cross-referencing engine. The map reduce engine may also comprise a classifiers component.

Additionally, a data layer API may be used to provide recommendations. The recommendations may be integrated into a sales solution implementation so as to affect customer sales activities. Based on the customer sales activities, feedback may be provided back to the data layer API. In examples, a sales solution implementation may include a customer history component, a customer activity component, a customer preference component, and a third tier activity component.

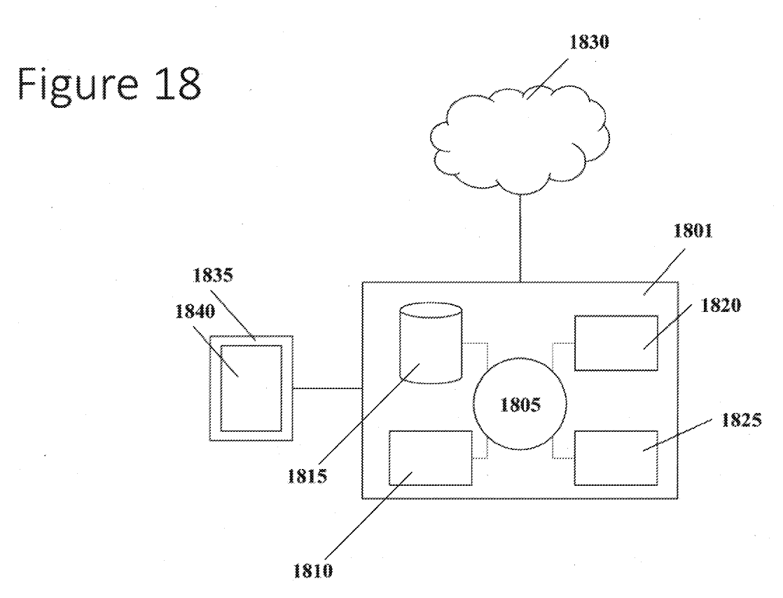

FIG. 18 shows a system 1801 that is programmed or otherwise configured to provide recommendations to identify and/or engage potential customers. In some cases, the recommendations may be provided based on the node profile and graph. In some cases, the recommendations may be provided based on the node profile, graph, and may further be independent of additional information. The computer system 1801 includes a central processing unit (CPU, also “processor” and “computer processor” herein) 1805, which can be a single core or multi core processor, or a plurality of processors for parallel processing. The computer system 1801 also includes memory or memory location 1810 (e.g., random-access memory, read-only memory, flash memory), electronic storage unit 1815 (e.g., hard disk), communication interface 1820 (e.g., network adapter) for communicating with one or more other systems, and peripheral devices 1825, such as cache, other memory, data storage and/or electronic display adapters. The memory 1810, storage unit 1815, interface 1820 and peripheral devices 1825 are in communication with the CPU 1805 through a communication bus (solid lines), such as a motherboard. The storage unit 1815 can be a data storage unit (or data repository) for storing data. The computer system 1801 can be operatively coupled to a computer network (“network”) 1830 with the aid of the communication interface 1820. The network 1830 can be the Internet, an internet and/or extranet, or an intranet and/or extranet that is in communication with the Internet. The network 1830 in some cases is a telecommunication and/or data network. The network 1830 can include one or more computer servers, which can enable distributed computing, such as cloud computing. The network 1830, in some cases with the aid of the computer system 1801, can implement a peer-to-peer network, which may enable devices coupled to the computer system 1801 to behave as a client or a server.

The CPU 1805 can execute a sequence of machine-readable instructions, which can be embodied in a program or software. The instructions may be stored in a memory location, such as the memory 1810. Examples of operations performed by the CPU 1805 can include fetch, decode, execute, and writeback.

The CPU 1805 can be part of a circuit, such as an integrated circuit. One or more other components of the system 1801 can be included in the circuit. In some cases, the circuit is an application specific integrated circuit (ASIC). The CPU 1805 can be programmed to perform one or more specific functions, such as any of the methods provided herein.

The storage unit 1815 can store files, such as drivers, libraries and saved programs. The storage unit 1815 can store user data, e.g., user preferences and user programs. The computer system 1801 in some cases can include one or more additional data storage units that are external to the computer system 1801, such as located on a remote server that is in communication with the computer system 1801 through an intranet or the Internet.

The computer system 1801 can communicate with one or more remote computer systems through the network 1830. For instance, the computer system 1801 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1801 via the network 1830.

Methods as described herein can be implemented by way of machine (e.g., computer processor) executable code stored on an electronic storage location of the computer system 1801, such as, for example, on the memory 1810 or electronic storage unit 1815. The machine executable or machine readable code can be provided in the form of software. Additionally, the machine executable or machine readable code may be tailored to implement methods of the invention as described herein. In some examples, the code may be tailored to provide recommendations to identify and/or engage potential customers. During use, the code can be executed by the processor 1805. In some cases, the code can be retrieved from the storage unit 1815 and stored on the memory 1810 for ready access by the processor 1805. In some situations, the electronic storage unit 1815 can be precluded, and machine-executable instructions are stored on memory 1810.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 401, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1801 can include or be in communication with an electronic display 1835 that comprises a user interface (UI) 1840 for providing, for example, deals of potential interest to users. Examples of UI's include, without limitation, a graphical user interface (GUI) and web-based user interface.

In some examples, the UI can include a window for presenting recommendations to identify and/or engage potential customers to a user. The UI can also display one or more other characteristics that are associated with such potential customers. The one or more other characteristics can be individuals, organizations (e.g., companies), recommendations of when to engage a potential customer, etc.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for providing recommendations to identify and/or engage potential customers, comprising:
(a) determining a plurality of characteristics of a node profile associated with a set of potential customers;
(b) using a computer processor that is programmed to identify characteristics of potential customers, analyzing an entity-based data intelligence layer to identify node profiles that match at least a threshold number of the plurality of characteristics associated with the set of potential customers;
(c) associating one or more recommendations with the identified node profiles of potential customers; and
(d) presenting said one or more recommendations of potential customers to the user.

2. The method of claim 1, wherein said one or more recommendations include contact information associated with the potential customers.

3. The method of claim 1, wherein said one or more recommendations are presented on a graphical user interface of a device of the user.

4. The method of claim 1, wherein said plurality of characteristics include an indication that potential customers have indicated an interest in a product associated with the user.

5. The method of claim 1, wherein each of said node profiles of said potential customers has at least one shared connection with the user.

6. The method of claim 1, wherein at least one node profile is a composite profile generated from multiple profiles that are associate with a potential customer.

7. The method of claim 6, wherein said multiple profiles are combined based on disambiguation processes.

8. The method of claim 1, wherein said data intelligence layer comprises a structure of connections between entities.

9. The method of claim 1, wherein said data intelligence layer comprises a graph that illustrates connections between entities.

10. The method of claim 1, wherein recommendations are presented to the user independent of a search input box.

11. A computer system for providing recommendations to identify and/or engage potential customers, comprising:
an electronic display comprising a user interface that is configured to present recommendations to a user; and
a computer processor coupled to said electronic display, wherein said computer processor is programmed to (i) determine a plurality of characteristics of a node profile associated with a set of potential customers; (ii) analyze an entity-based data intelligence layer to identify node profiles that match at least a threshold number of the plurality of characteristics associated with the set of potential customers; (iii) associate one or more recommendations with the identified node profiles of potential customers; and (iv) present said one or more recommendations of potential customers to the user.

12. The computer system of claim 11, wherein said one or more recommendations of potential customers are presented on said electronic display.

13. The computer system of claim 11, wherein said one or more recommendations include recommended times for engaging said potential customers.

14. The computer system of claim 13, wherein said one or more recommendations include recommendation times selected from the group consisting of: hour of a day, day of a week, and month of a year.

15. The computer system of claim 11, wherein said one or more recommendations include recommended media for engaging said potential customers.

16. The computer system of claim 15, wherein said one or more recommendations include recommendation media selected from the group consisting of: social media, e-mail, and text.

17. The computer system of claim 11, wherein said plurality of characteristics include an indication that potential customers have indicated an interest in a product associated with the user.

18. The computer system of claim 11, wherein said data intelligence layer comprises a structure of connections between entities.

19. The computer system of claim 11, wherein said data intelligence layer comprises a graph that illustrates connections between entities.

20. The computer system of claim 11, wherein recommendations are presented to the user independent of receiving a search request within a search input box.
